(19) United States
(12) Patent Application Publication
(10) Pub. No.: US 2006/0240345 A1
(43) Pub. Date: Oct. 26, 2006

(54) Photoreceptors

(75) Inventors: Cindy C. Chen, Rochester, NY (US); Lanhui Zhang, Webster, NY (US)

Correspondence Address: George Likourezos, Esq.;Carter, DeLuca, Farrell & Schmidt, LLP, Suite 225, 445 Broadhollow Road, Melville, NY, 11747, US

(73) Assignee: Xerox Corporation

(21) Appl. No.: 11/113,881

(22) Filed: Apr. 25, 2005

(51) Int. Cl. G03G 5/06

(52) U.S. Cl. 430/56; 430/135; 430/133

(57) ABSTRACT

Methods for adjusting the rheology of dispersions utilized to form layers of photoreceptors are provided.

### BACKGROUND

The present disclosure relates to imaging members and, more specifically, to methods for adjusting the rheology of dispersions utilized to form layers of imaging members and the use of these dispersions in forming photoreceptors.

Electrophotographic photoreceptors may be in the form of plates, rigid drums, flexible belts, and the like. Electrophotographic photoreceptors may be prepared with either a single layer configuration or a multilayer configuration. Multilayered photoreceptors may include a substrate, a conductive layer, an optional hole blocking layer, an optional adhesive layer, a charge generation layer, a charge transport layer, an optional overcoating layer and, in some belt embodiments, an anticurl backing layer. In the multilayer configuration, the active layers of the photoreceptor are the charge generation layer (CGL) and the charge transport layer (CTL).

One technique for coating cylindrical or drum shaped photoreceptor substrates to form these layers, including charge generation layers, involves dipping the substrates in coating baths. For example, baths used for preparing charge generation layers may be prepared by dispersing photoconductive pigment particles in a solution containing a film forming binder. Newtonian dispersions may be utilized for dip coating since uniformity in the charge generation layer is more likely to occur. Methods for forming such Newtonian dispersions include those found in U.S. Pat. No. 6,057,075, the entire disclosure of which is incorporated by reference herein, wherein a stable Newtonian coating dispersion may be formed by preparing a first stable Newtonian dispersion, and adding a polymer to said dispersion to form the stable Newtonian coating dispersion. The dispersion of U.S. Pat. No. 6,057,075 exhibits no yield point (the minimum force or shear stress required to initiate flow of a non-Newtonian dispersion).

Dispersions which may agglomerate are generally not suitable for dip coating applications due to settling, shear thinning, and other problems associated with changes in dispersion quality during dip coating, which may lead to non-uniform coating defects of the layer, including a charge generation layer, such as streaks which may cause defects in print quality.

Flexible photoreceptor belts are often fabricated by depositing layers of photoactive coatings onto long webs which are thereafter cut into sheets. Layers of such belt photoreceptors, such as charge generation layers, are often applied to belts by slot or slide coating of a dispersion.

Depending on the coating facility and the actual dispersion system utilized, different rheological properties of dispersions may be required for coating a photoreceptor. For example, a Newtonian dispersion with no yield point is adequate to form a uniform coating on a drum photoreceptor. However, a non-Newtonian dispersion with a yield point may be desirable for fast freezing-in the coated film of a dispersion with low viscosity on a flexible belt or web photoreceptor device. However, difficulties arise in utilizing non-Newtonian dispersions to coat belt or web photoreceptors due, in part, to the fact that it is not easy to uniformly mill the entire non-Newtonian dispersion. Therefore, some large particles that are greater in size than the acceptable size of the particulate additive for the given layer, may be present in the millbase. Methods to remove these large particles in non-Newtonian dispersions, such as centrifugation and conventional filtration, are generally inadequate because they also remove agglomerated particulates from the non-Newtonian dispersion that are within an acceptable size range for a given layer.

The cost to develop different layer coating dispersion formulations, and the need to change dispersions for different products in the manufacturing process, greatly increases the costs to manufacture photoreceptors.

### SUMMARY

The present disclosure provides methods for preparation of dispersions with tunable rheology for fabricating layers of a photoreceptor. The method includes contacting a particulate additive and a first binder resin in a liquid to form a Newtonian millbase and contacting the millbase with a let down solution comprising a second binder resin and a solvent to obtain a non-Newtonian dispersion. The rheology of the dispersion utilized to form the layer can advantageously be adjusted depending upon the nature of the binder and liquid system with respect to the specific particulate additive included in the layer.

In embodiments, where the layer produced is a charge generation layer and the particulate additive is a pigment, the method includes preparing a Newtonian millbase by combining a pigment, a binder resin and a liquid, and contacting the millbase with at least one let down solution to obtain a non-Newtonian dispersion having a desired ratio of pigment to binder. Because the starting millbase is Newtonian, centrifugation may be utilized in embodiments to remove large particles or clumps that may be present in the millbase. By adding the appropriate let down solution, non-Newtonian dispersions may be formed without such large particles or clumps that are suitable for web and belt applications.

In embodiments, large particulates, large particles, and/or clumps refer, for example, to particulate additive of a size greater than that deemed acceptable for the layer including such particulate additive. While agglomerates of particulate additives may be acceptable in embodiments, large particles or clumps above a given size are undesirable. For example, in embodiments where the layer to be applied is a charge generation layer, the size of the particulate additive, a pigment, may be about 200 nm in diameter. Clumps or large particles of pigment larger than this size in a charge generation layer may cause charge deficient spots and compromise print quality. Thus, a large particle for a charge generation dispersion possessing such an additive would be a clump of particulate additive greater than about 200 nm, in embodiments from about 300 nm or larger.

Photoreceptors possessing such layers are also provided.

### BRIEF DESCRIPTION OF THE DRAWINGS

Various embodiments of the present disclosure will be described herein below with reference to the figures wherein:

FIG. 1 is a graph depicting the rheological properties of illustrative dispersions prepared in accordance with the present disclosure; and

FIG. 2 is a collection of photographs depicting the results of flow visualization tests of the dispersions described in FIG. 1.

### DETAILED DESCRIPTION OF THE PREFERRED EMBODIMENTS

The present disclosure provides a method for preparing dispersions suitable for use in forming a layer of a photoreceptor. In embodiments, the dispersions include particulate additives. Depending upon the nature of the substrate to which the dispersions are to be applied and the method selected for coating, the dispersions can be formulated to exhibit Newtonian, near-Newtonian, or non-Newtonian rheological properties to comply with the coating conditions for the photoreceptor. In embodiments, the dispersion is formulated to exhibit non-Newtonian or near-Newtonian properties and is applied to a web or belt photoreceptor.

In embodiments, Newtonian refers, for example, to a phenomenon that the shear rate of a fluid increases linearly with shear stress and shear viscosity does not vary with shear rate. In embodiments, non-Newtonian includes near-Newtonian and refers, for example, to a phenomenon that the shear rate of a fluid does not increase linearly with shear stress and the viscosity varies as the shear rate is varied.

A Newtonian millbase or masterbatch may be prepared by combining a particulate additive, a binder resin, and a liquid. The resulting Newtonian millbase, a dispersion, is combined with a let down composition, for example, a second binder in solution, to provide a non-Newtonian or near-Newtonian dispersion possessing a target particulate additive/binder ratio and concentration. As the starting millbase is Newtonian, it may be subjected to methods, for example centrifugation or filtration, to remove any large particulates. These methods would not otherwise be suitable for a non-Newtonian or near-Newtonian millbase because they would unnecessarily remove suitable agglomerates of particulate additive from the non-Newtonian or near-Newtonian millbase dispersion. Thus, utilizing the methods of the present disclosure, a non-Newtonian dispersion may be prepared that is suitable for application to a web or belt photoreceptor.

Dispersions for forming charge transport layers may be prepared with hole transport molecules and/or additional particulate additives including low surface energy fluoropolymers, metal oxides and/or non-metal oxides; charge generation layers may be prepared with pigments as the particulate additive; overcoat layers may be prepared with low surface energy fluoropolymers, metal oxides and/or non-metal oxides as the particulate additive, and the like.

In embodiments, the methods of the present disclosure may be utilized to form non-Newtonian or near-Newtonian dispersions for forming charge generation layers of photoreceptors. Examples of suitable binder resins for use in preparing the millbase dispersion for a charge generation layer include thermoplastic and thermosetting resins such as polycarbonates, polyesters including poly(ethylene terephthalate), polyurethanes including poly(tetramethylene hexamethylene diurethane), polystyrenes including poly(styrene-co-maleic anhydride), polybutadienes including polybutadiene-graft-poly(methyl acrylate-co-acrylontrile), polysulfones including poly(1,4-cyclohexane sulfone), polyarylethers including poly(phenylene oxide), polyarylsulfones including poly(phenylene sulfone), polyethersulfones including poly(phenylene oxide-co-phenylene sulfone), polyethylenes including poly(ethylene-co-acrylic acid), polypropylenes, polymethylpentenes, polyphenylene sulfides, polyvinyl acetates, polyvinylbutyrals, polysiloxanes including poly(dimethylsiloxane), polyacrylates including poly(ethyl acrylate), polyvinyl acetals, polyamides including poly(hexamethylene adipamide), polyimides including poly(pyromellitimide), amino resins including poly(vinyl amine), phenylene oxide resins including poly(2,6-dimethyl-1,4-phenylene oxide), terephthalic acid resins, phenoxy resins including poly(hydroxyethers), epoxy resins including poly([(o-cresyl glycidyl ether)-co-formaldehyde], phenolic resins including poly(4-tert-butylphenol-co-formaldehyde), polystyrene and acrylonitrile copolymers, polyvinylchlorides, polyvinyl alcohols, poly-N-vinylpyrrolidinones, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and the like, and combinations thereof. These polymers may be block, random, or alternating copolymers.

Examples of suitable polycarbonates which may be utilized to form the millbase dispersion include, but are not limited to, poly(4,4′-isopropylidene diphenyl carbonate) (also referred to as bisphenol A polycarbonate), poly(4,4′-diphenyl-1,1′-cyclohexane carbonate) (also referred to as bisphenol Z polycarbonate, polycarbonate Z, or PCZ), poly(4,4′-sulfonyl diphenyl carbonate) (also referred to as bisphenol S polycarbonate), poly(4,4′-ethylidene diphenyl carbonate) (also referred to as bisphenol E polycarbonate), poly(4,4′-methylidene diphenyl carbonate) (also referred to as bisphenol F polycarbonate), poly(4,4′-(1,3-phenylenediisopropylidene)diphenyl carbonate) (also referred to as bisphenol M polycarbonate), poly(4,4′-(1,4-phenylenediisopropylidene)diphenyl carbonate) (also referred to as bisphenol P polycarbonate), poly(4,4′-hexafluoroisppropylidene diphenyl carbonate).

The molecular weight of the binder resin used to form the millbase may range from about 10,000 to about 100,000, in embodiments from about 15,000 to about 50,000.

In embodiments, a single binder resin may be utilized to form the millbase of the present disclosure. In other embodiments, a mixture of more than one of the above binder resins can be used to form the millbase of the present disclosure. Where more than one binder resin is utilized, the number of binder resins can range from about 2 to about 4, in embodiments from about 2 to about 3.

A liquid or liquid mixture may be used in preparing the millbase. A liquid mixture may include from about 2 to about 4 liquids, in embodiments from about 2 to about 3 liquids. In embodiments, the liquid is a solvent for the binder resin, but not the particulate additive. The binder resin may be added to the liquid, in embodiments a solvent for the binder resin, to form a solution and the pigment then added to the solution to form the millbase dispersion. The liquid utilized should not substantially disturb or adversely affect other layers of the photoreceptor, if any. Examples of liquids that can be utilized in preparing the millbase include, but are not limited to, ketones, alcohols, aromatic hydrocarbons, halogenated aliphatic hydrocarbons, ethers, amines, amides, esters, mixtures thereof, and the like. Specific illustrative examples include cyclohexanone, acetone, methyl ethyl ketone, methanol, ethanol, butanol, amyl alcohol, toluene, xylene, monochlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, mixtures thereof, and the like.

The binder resin in a liquid, which is a solvent for the binder resin, is combined with a particulate additive to form the millbase dispersion. Thus, for example, in embodiments where a dispersion of the present disclosure is to be utilized to from a charge generation layer of a photoreceptor, the particulate additive is a pigment. Suitable pigments which may be utilized include any photogenerating pigment such as metal phthalocyanines, metal free phthalocyanines, alkylhydroxyl gallium phthalocyanine, hydroxygallium phthalocyanines, perylenes, especially bis(benzimidazo)perylene, titanyl phthalocyanines, and the like. In embodiments, vanadyl phthalocyanines, Type V hydroxygallium phthalocyanines and inorganic components such as selenium, selenium alloys, and trigonal selenium may be utilized as the pigment.

In embodiments, hydroxygallium phthalocyanaine (HOGaPc) is utilized as the pigment in the charge generation layer. U.S. Pat. Nos. 5,521,306 and 5,473,064, the entire disclosures of each of which are incorporated by reference herein, describe HOGaPc and processes to prepare Type V hydroxygallium phthalocyanine. HOGaPc is most responsive at a range of, for example, about 550 nanometers to about 880 nanometers and is generally unresponsive to the light spectrum below about 500 nanometers. Typical wavelengths for photogeneration are about 600 nanometers to about 850 nanometers and may include a broadband between the two wavelengths.

Any suitable technique may be utilized to disperse the particulate additive in the binder resin or resins. The dispersion containing the pigment may be formed using, for example, attritors, ball mills, Dynomills, paint shakers, homogenizers, microfluidizers, mechanical stirrers, in-line mixers, ultrasonic processor, Cavipro processor, or by any other suitable milling techniques.

Specific dispersion techniques which may be utilized include, for example, ball milling, roll milling, milling in vertical or horizontal attritors, sand milling, and the like. The solids content of the mixture being milled can be selected from a wide range of concentrations. Milling times using a ball roll mill may be between about 6 hours and about 6 days, in embodiments from about 8 hours to about 3 days. If desired, the particulate additive with or without binder resin may be milled in the absence of a liquid prior to forming the final non-Newtonian coating dispersion.

For dispersions utilized to form charge generation layers, the amount of binder resin in the millbase can be from about 99.5% by weight to about 15% by weight of the millbase solids, typically from about 65% by weight to about 20% by weight of the millbase solids. The amount of pigment in the millbase can be from about 0.5% by weight to about 85% by weight of the millbase solids, typically from about 35% by weight to about 80% by weight of the millbase solids. The expression “solids” refers to the total pigment and binder components of the millbase dispersion.

It may be desirable for dispersion optimization to utilize methods such as centrifugation or filtration to remove undesired large particles, including pigments, from the Newtonian millbase prior to formation of the non-Newtonian coating dispersion. Large pigment particles are believed to be a major cause of charge deficient spot problems. While centrifuging or filtration may not be a suitable treatment for a non-Newtonian millbase because it would unnecessarily remove particulate additive from the dispersion, including agglomerates which are of suitable size and adequately milled, it may be utilized with the Newtonian millbase of the present disclosure to remove large particles from the Newtonian millbase while the adequately milled particles remain in dispersion.

Centrifuging may occur at a rate of from about 2000 rpm to about 10000 rpm, in embodiments from about 2800 rpm to about 8000 rpm, for a period of time ranging from about 10 minutes to about 2 hours, in embodiments from about 15 minutes to about 1 hour. Thus, the centrifugal force applied to the dispersion may range from about 500 g to about 8000 g, in embodiments from about 700 g to about 5000 g, where g=9.8 meters/second². The centrifugation can be run at either discrete or continuous modes.

Once the Newtonian millbase has been prepared, a separate let down composition containing one or more binder resins and a solvent or solvent mixture is prepared and combined with the millbase. Where more than one binder resin is utilized, the number of binder resins in the let down composition can range from about 2 to about 4 binder resins, in embodiments from about 2 to about 3 binder resins. Where a solvent mixture is utilized to form the let down composition, the number of solvents can range from about 2 to about 4 solvents, in embodiments from about 2 to about 3 solvents. Alternatively, one to about 4 let down solutions, in embodiments from one to about 3 let down solutions can be separately prepared and combined with the millbase.

The binder resin utilized in the let down solution or solutions to dilute the millbase may be the same or different as the binder resin utilized to form the millbase. Similarly, the solvent utilized in the let down solution or solutions to dilute the millbase may be the same or different as the liquid utilized to form the millbase.

The amount of binder resin or resins in the let down composition can range from about 0% by weight to about 50% by weight of the let down composition, in embodiments from about 0% by weight to about 15% by weight of the let down composition.

The amount of let down solution added to the millbase may range from about 0% to about 800% by weight of the millbase, in embodiments from about 20% to about 200% by weight of the millbase. In embodiments the resulting dispersion possesses non-Newtonian or near-Newtonian properties.

In embodiments, a Newtonian millbase of particulate additive, such as a pigment, binder resin and liquid may be prepared and then centrifuged to remove undesired large/under-milled particles for dispersion optimization. The centrifuged millbase may then be let down to the target pigment/binder ratio and concentration using the let down solution to form a dispersion. By controlling the ratio of the binders utilized in the millbase and let down solution, dispersions with different rheological properties can be obtained, ranging from Newtonian to near-Newtonian to Non-Newtonian. In embodiments the coating dispersion is non-Newtonian.

For example, when a specific amount or percentage of pigment is needed to achieve a charge generation layer of the present disclosure, a millbase can be prepared as described above and then can be “let down” by addition of a let down composition to obtain the desired amount of pigment in the resulting charge generation layer. For example, if the desired pigment level in the charge generation layer is 25% by weight based on the total weight of the layer, a 50% pigment millbase, for example, can be let down. In embodiments, the term “let down” can refer, for example, to the reduction of the percentage of pigment from z in the millbase to z′ in the final dispersion:
(w)(z)=(w′)(z′)
wherein

w is the amount of the pigment millbase,

z is the percentage of pigment in the pigment millbase,

w′ is the amount of the final dispersion utilized to produce a charge generation layer (in the same units as w), and

z′ is the percentage of pigment in the final dispersion utilized to produce a charge generation layer of the present disclosure.

Therefore, in the above example, if w′ is 100 pounds, z′ is 25% and z is 50%, then 50 pounds of the 50% pigment millbase would be needed to produce a final dispersion for charge generation layer having a pigment concentration of 25%.

The millbase in combination with the let down composition produces a charge generation dispersion which may be applied to another layer of a photoreceptor to form a charge generation layer of a photoreceptor.

In embodiments, the dispersion forming the layer of a photoreceptor may contain two binder resins, for example, the first binder resin utilized in preparing the millbase and a second binder resin utilized in the let down composition. Similarly, the dispersion utilized to form the layer of a photoreceptor may contain the liquid used in preparing the millbase and a solvent utilized in preparing the let down composition. As discussed above, where multiple let down solutions are utilized to form the dispersion for forming the layer of a photoreceptor, the dispersion will contain those binder resins, liquids and solvents utilized to form the millbase and the let down compositions.

The dispersion utilized to form the layer of a photoreceptor possesses the desired ratio of particulate additive to total binders, for a charge generation layer a ratio of pigment to binder, ranging from about 85:15 to about 0.5:99.5 by weight, in embodiments from about 80:20 to about 35:65 by weight. The dispersion utilized to form the layer of a photoreceptor possesses a desired concentration of solids ranging from about 2 weight percent to about 15 weight percent of the dispersion, in embodiments from about 3 weight percent to about 8 weight percent of the dispersion.

By selecting the appropriate second binder resin in the let down composition and adjusting the ratio of the second binder resin to the first binder resin in the millbase, dispersions for forming a layer of a photoreceptor, such as a charge generation layer, with desired rheological properties suitable for the coating conditions being utilized, can be prepared. For example, charge generation dispersions applied to substrates for use in an organic photoconductor (OPC) drum photoreceptor are typically Newtonian dispersions. However, charge generation dispersions suitable for use with active matrix photoconductor (AMAT) belt photoreceptors typically include non-Newtonian dispersions; the rheological properties of these dispersions may be desirable to enable the fast freezing of the thin coating on substrate. Utilizing the methods of the present disclosure, a Newtonian millbase of particulate additive/resin may be prepared and then combined with different let down compositions to form various dispersions, the rheology of which may be adjusted depending on the coating facility and the substrate to which the dispersion is to be applied. Thus, in embodiments, a Newtonian millbase may be obtained, treated by centrifuging (which would not be suitable for a non-Newtonian millbase) to remove large particles, and then combined with a let down solution to produce a non-Newtonian dispersion possessing a yield point which is suitable for application to flexible belt or web photoreceptors.

Any suitable and conventional technique may be utilized to combine and thereafter apply the charge generation dispersion to another layer of a photoreceptor including, but not limited to, dip coating, roll coating, spray coating, rotary atomizers, and the like. The coating techniques may use a wide concentration of solids. The solids content may range from about 2 percent by weight to about 15 percent by weight based on the total weight of the dispersion, in embodiments ranging from about 3 percent by weight to about 8 percent by weight based on the total weight of the dispersion. These solids concentrations are useful in dip coating, roll coating, spray coating, and the like.

The dispersions of the present disclosure may be applied to a substrate or any previously applied layer of a photoreceptor to form the desired layer, in embodiments a charge generation layer, of a belt photoreceptor by slot coating, slide coating, die coating, or roll coating techniques. In embodiments, dip coating may be used to apply the dispersion to form the desired layer, in embodiments a charge generation layer, of a drum photoreceptor. Drying of the deposited coating may be effected by any suitable conventional technique such as oven drying, infrared radiation drying, air drying and the like.

For charge generation layers, the pigment may be present in the charge generation layer of a photoreceptor in an amount of from about 0.5 percent to about 85 percent by weight of the charge generation layer and, in embodiments, from about 35 percent to about 80 percent by weight of the charge generation layer. Thus, the polymeric binder may be present in an amount ranging from about 15 percent to about 99.5 percent by weight of the charge generation layer of a photoreceptor and, in embodiments, from about 20 percent to about 65 percent by weight of the charge generation layer, although the relative amounts can be outside these ranges. By adjusting the materials utilized to form the millbase and let down compositions, charge generation layers of photoreceptors with a desired ratio of pigment to binder may be formed. Furthermore, by selecting an appropriate second binder in the let down compositions, and adjusting the ratio of the second binder to the first binder, for example, the binder in the Newtonian millbase, non-Newtonian dispersions may be prepared for forming charge generation layers.

Once formed, the charge generation layer containing pigment and binder resin generally ranges in thickness ranging from about 0.05 micrometers to about 10 micrometers, in embodiments from about 0.1 micrometers to about 5 micrometers, in other embodiments from about 0.3 micrometers to about 3 micrometers, although the thickness can be outside these ranges. The charge generation layer thickness is related to the relative amounts of pigment and binder resin. Lower pigment content compositions generally require thicker layers for photogeneration. It may be desirable to provide this layer in a thickness sufficient to absorb about 90 percent or more of the incident radiation which is directed upon it in the imagewise or printing exposure step. The optimal thickness of the charge generation layer depends upon factors such as electrical considerations including dark decay, charge depletion, and the like, mechanical considerations, the specific pigment selected, the thicknesses of the other layers, and whether a flexible photoconductive imaging member is desired.

The methods of the present disclosure may be utilized to form charge generation layers for use with any known configuration of photoreceptors. Suitable configurations of multi-layer photoreceptors include the photoreceptors described in U.S. Pat. Nos. 6,800,411, 6,824,940, 6,818,366, 6,790,573, and U.S. Patent Application Publication No. 20040115546, the entire contents of each of which are incorporated by reference herein. Photoreceptors typically possess a charge generation layer (CGL), also referred to herein as a photogenerating layer, and a charge transport layer (CTL). Other layers, including a substrate, an electrically conductive layer, a charge blocking or hole blocking layer, an adhesive layer, and/or an overcoat layer, may also be present in the photoreceptor.

Suitable substrates which may be utilized in forming a photoreceptor include opaque or substantially transparent substrates, and may include any suitable organic or inorganic material having the requisite mechanical properties.

The substrate may be flexible, seamless, or rigid and may be of a number of different configurations such as, for example, a plate, a cylindrical drum, a scroll, an endless flexible belt, a web, and the like.

The thickness of the substrate layer may depend on numerous factors, including mechanical performance and economic considerations. For rigid substrates, the thickness of the substrate can range from about 0.3 millimeters to about 10 millimeters, in embodiments from about 0.5 millimeters to about 5 millimeters. For flexible substrates, the substrate thickness can range from about 65 to about 200 micrometers, in embodiments from about 75 to about 100 micrometers, for optimum flexibility and minimum stretch when cycled around small diameter rollers of, for example, 19 millimeter diameter. The entire substrate can be made of an electrically conductive material, or the electrically conductive material can be a coating on a polymeric substrate.

Substrate layers selected for the imaging members of the present disclosure, and which substrates can be opaque or substantially transparent, may include a layer of insulating material including inorganic or organic polymeric materials such as MYLAR® (a commercially available polymer from DuPont), MYLAR® containing titanium, a layer of an organic or inorganic material having a semiconductive surface layer, such as indium tin oxide or aluminum arranged thereon, or a conductive material inclusive of aluminum, chromium, nickel, brass, or the like.

Any suitable electrically conductive material can be employed with the substrate. Suitable electrically conductive materials include copper, brass, nickel, zinc, chromium, stainless steel, conductive plastics and rubbers, aluminum, semi-transparent aluminum, steel, cadmium, silver, gold, zirconium, niobium, tantalum, vanadium, hafnium, titanium, nickel, chromium, tungsten, molybdenum, paper rendered conductive by the inclusion of a suitable material therein, or through conditioning in a humid atmosphere to ensure the presence of sufficient water content to render the material conductive, indium, tin, metal oxides, including tin oxide and indium tin oxide, and the like.

After formation of an electrically conductive surface, a hole blocking layer may optionally be applied to the substrate layer. Generally, hole blocking layers (also referred to as charge blocking layers) allow electrons from the conductive layer to migrate toward the charge generation layer. Any suitable blocking layer capable of forming an electronic barrier to holes between the adjacent charge generation layer and the underlying conductive layer of the substrate may be utilized. Suitable blocking layers include those disclosed, for example, in U.S. Pat. Nos. 4,286,033, 4,291,110 and 4,338,387, the entire disclosures of each of which are incorporated herein by reference. Similarly, illustrated in U.S. Pat. Nos. 6,255,027, 6,177,219, and 6,156,468, the entire disclosures of each of which are incorporated herein by reference, are, for example, photoreceptors containing a hole blocking layer of a plurality of light scattering particles dispersed in a binder. For example, Example 1 of U.S. Pat. No. 6,156,468 discloses a hole blocking layer of titanium dioxide dispersed in a linear phenolic binder.

Typical hole blocking layers utilized for negatively charged photoconductors may include, for example, polyamides including LUCKAMIDE® (a nylon type material derived from methoxymethyl-substituted polyamide commercially available from Dai Nippon Ink), hydroxy alkyl methacrylates, nylons, gelatin, hydroxyl alkyl cellulose, organopolyphosphazines, organosilanes, organotitanates, organozirconates, metal oxides of titanium, chromium, zinc, tin, silicon, and the like. In embodiments the hole blocking layer may include nitrogen containing siloxanes. Typical nitrogen containing siloxanes may be prepared from coating solutions containing a hydrolyzed silane. Typical hydrolyzable silanes include 3-aminopropyl triethoxy silane, N,N′-dimethyl 3-amino)propyl triethoxysilane, N,N-dimethylamino phenyl triethoxy silane, N-phenyl aminopropyl trimethoxy silane, trimethoxy silylpropyldiethylene triamine and mixtures thereof.

In embodiments, the hole blocking components may be combined with phenolic compounds, a phenolic resin, or a mixture of more than one phenolic resin, for example, from about 2 to about 4 phenolic resins. Suitable phenolic compounds which may be utilized may contain at least two phenol groups, such as bisphenol A (4,4′-isopropylidenediphenol), bisphenol E (4,4′-ethylidenebisphenol), bisphenol F (bis(4-hydroxyphenyl)methane), bisphenol M (4,4′-(1,3-phenylenediisopropylidene)bisphenol), bisphenol P (4,4′-(1,4-phenylene diisopropylidene)bisphenol), bisphenol S (4,4′-sulfonyldiphenol), and bisphenol Z (4,4′-cyclohexylidenebisphenol), hexafluorobisphenol A (4,4′-(hexafluoro isopropylidene)diphenol), resorcinol, hydroxyquinone, catechin, and the like.

The hole blocking layer may be applied as a coating on a substrate or electrically conductive layer by any suitable conventional technique such as spraying, die coating, dip coating, draw bar coating, gravure coating, silk screening, air knife coating, reverse roll coating, vacuum deposition, chemical treatment, and the like. For convenience in obtaining thin layers, the blocking layers may be applied in the form of a dilute solution, with the solvent being removed after deposition of the coating by conventional techniques such as by vacuum, heating and the like. Drying of the deposited coating may be effected by any suitable conventional technique such as oven drying, infrared radiation drying, air drying and the like.

The blocking layer may be continuous and have a thickness of from about 0.01 micrometers to about 30 micrometers, typically from about 0.1 micrometers to about 20 micrometers.

An optional adhesive layer may be applied to the hole blocking layer. Any suitable adhesive layer known in the art may be utilized including, but not limited to, polyesters, polyamides, poly(vinyl butyral), poly(vinyl alcohol), polyurethane and polyacrylonitrile. Where present, the adhesive layer may be, for example, of a thickness of from about 0.001 micrometers to about 2 micrometers, in embodiments from about 0.01 micrometers to about 1 micrometers. Optionally, the adhesive layer may contain effective suitable amounts, for example from about 1 weight percent to about 10 weight percent, of conductive and nonconductive particles, such as zinc oxide, titanium dioxide, silicon nitride, carbon black, and the like, to provide further desirable electrical and optical properties to the photoreceptor of the present disclosure. Conventional techniques for applying an adhesive layer coating mixture to the hole blocking layer include spraying, dip coating, roll coating, wire wound rod coating, gravure coating, die coating and the like. Drying of the deposited coating may be effected by any suitable conventional technique such as oven drying, infrared radiation drying, air drying and the like.

In embodiments the photoreceptor also includes a charge transport layer attached to the charge generation layer. The charge transport layer typically includes a charge transport or hole transport molecule (HTM) dispersed in an inactive polymeric material. These compounds may be added to polymeric materials which are otherwise incapable of supporting the injection of photogenerated holes from the charge generation layer and incapable of allowing the transport of these holes therethrough. The addition of these HTMs converts the electrically inactive polymeric material to a material capable of supporting the direction of photogenerated holes from the charge generation layer and capable of allowing the transport of these holes through the charge transport layer in order to discharge the surface charge on the charge transport layer.

Suitable polymers for use in forming the charge transport layer are film forming binder resins known to those skilled in the art. Examples include those polymers utilized to form the charge generation layer. In embodiments resin materials for use in forming the charge transport layer are electrically inactive resins including polycarbonate resins having a weight average molecular weight from about 20,000 to about 150,000, typically from about 50,000 about 120,000. Electrically inactive resin materials which may be utilized in the charge transport layer include poly(4,4′-dipropylidene-diphenylene carbonate) with a weight average molecular weight of from about 35,000 to about 40,000, available as LEXAN® 145 from General Electric Company; poly(4,4′-propylidene-diphenylene carbonate) with a weight average molecular weight of from about 40,000 to about 45,000, available as LEXAN® 141 from the General Electric Company; a polycarbonate resin having a weight average molecular weight of from about 50,000 to about 100,000, available as MAKROLON® from Farbenfabricken Bayer A.G.; a polycarbonate resin having a weight average molecular weight of from about 20,000 to about 50,000 available as MERLON® from Mobay Chemical Company; and a polycarbonate resin having a weight average molecular weight of from about 20,000 to about 80,000 available as PCZ from Mitsubishi Chemicals. Solvents such as methylene chloride, tetrahydrofuran, toluene, monochlorobenzene, or mixtures thereof, may be utilized in forming the charge transport layer coating mixture.

Any suitable charge transporting or electrically active molecules known to those skilled in the art may be employed as HTMs in forming a charge transport layer on a photoreceptor. Suitable charge transporting molecules include, for example, aryl amines as disclosed in U.S. Pat. No. 4,265,990, the entire contents of which are incorporated by reference herein. In embodiments, an aryl amine charge hole transporting component may be represented by: 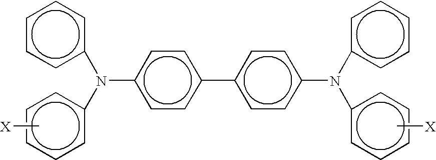
wherein X can be alkyl, halogen, alkoxy or mixtures thereof. Typically, the halogen is a chloride. Alkyl groups may contain, for example, from about 1 to about 10 carbon atoms and, in embodiments, from about 1 to about 5 carbon atoms. Examples of suitable aryl amines include, but are not limited to, N,N′-diphenyl-N,N′-bis(alkylphenyl)-1,1-biphenyl-4,4′-diamine, wherein the alkyl may be methyl, ethyl, propyl, butyl, hexyl, and the like; and N,N′-diphenyl-N,N′-bis(halophenyl)-1,1′-biphenyl-4,4′-diamine, wherein the halo may be a chloro, bromo, fluoro, and the like substituent.

Other suitable aryl amines which may be utilized as an HTM in a charge transport layer include, but are not limited to, tritolylamine, N,N′-bis(3,4 dimethylphenyl)-N″(1-biphenyl)amine, 2-bis((4′-methylphenyl)amino-p-phenyl) 1,1-diphenyl ethylene, 1-bisphenyl-diphenylamino-1-propene, triphenylmethane, bis(4-diethylamine-2-methylphenyl)phenylmethane, 4′-4″-bis(diethylamino)-2′,2″-dimethyltriphenylmethane, N,N′-bis(alkylphenyl)-[1,1′-biphenyl]-4,4′-diamine wherein the alkyl is, for example, methyl, ethyl, propyl, n-butyl, etc., N,N′-diphenyl-N,N′-bis(3″-methylphenyl)-(1,1′-biphenyl)-4,4′-diamine, and the like.

The weight ratio of the polymer binder to charge transport molecules in the resulting charge transport layer can range, for example, from about 30/70 to about 80/20. In embodiments the weight ratio of the polymer binder to charge transport molecules can range from about 35/65 to about 75/25, typically from about 40/60 to about 70/30.

Any suitable and conventional technique may be utilized to mix the polymer binder in combination with the hole transport material and apply same as a charge transport layer to a photoreceptor. In embodiments, it may be advantageous to add the polymer binder and hole transport material to a solvent to aid in formation of a charge transport layer and its application to a photoreceptor. Examples of solvents which may be utilized include aromatic hydrocarbons, aliphatic hydrocarbons, halogenated hydrocarbons, ethers, amides and the like, or mixtures thereof. In embodiments, a solvent such as cyclohexanone, cyclohexane, chlorobenzene, carbon tetrachloride, chloroform, methylene chloride, trichloroethylene, toluene, tetrahydrofuran, dioxane, dimethyl formamide, dimethyl acetamide and the like, may be utilized in various amounts. Typical application techniques of the charge transport layer include spraying, slot or slide coating, dip coating, roll coating, wire wound rod coating, and the like. Drying of the deposited coating may be effected by any suitable conventional technique such as oven drying, infrared radiation drying, air drying and the like.

The thickness of the charge transport layer can range from about 2 micrometers and about 50 micrometers, in embodiments from about 10 micrometers to about 35 micrometers. The charge transport layer should be an insulator to the extent that the electrostatic charge placed on the charge transport layer is not conducted in the absence of illumination at a rate sufficient to prevent formation and retention of an electrostatic latent image thereon. In general, the ratio of the thickness of the charge transport layer to the charge generation layer, where present, is typically from about 2:1 to 200:1 and in some instances as great as 400:1.

The charge generation layer, charge transport layer, and other layers may be applied in any suitable order to produce either positive or negative charging photoreceptors. For example, the charge generation layer may be applied prior to the charge transport layer, as illustrated in U.S. Pat. No. 4,265,990, or the charge transport layer may be applied prior to the charge generation layer, as illustrated in U.S. Pat. No. 4,346,158, the entire disclosures of each of which are incorporated by reference herein. When used in combination with a charge transport layer, the charge generation layer may be sandwiched between a conductive surface and a charge transport layer or the charge transport layer may be sandwiched between a conductive surface and a charge generation layer.

Optionally, an overcoat layer may be applied to the surface of a photoreceptor to improve resistance to abrasion. In some cases, an anti-curl back coating may be applied to the side of the substrate opposite the active layers of the photoreceptor (i.e., the CGL and CTL) to provide flatness and/or abrasion resistance where a web configuration photoreceptor is fabricated. These overcoating and anti-curl back coating layers are well known in the art and may include thermoplastic organic polymers or inorganic polymers that are electrically insulating or slightly semi-conductive. For example, overcoat layers may be fabricated from a dispersion including a particulate additive in a binder resin. Suitable particulate additives for overcoat layers include metal oxides including aluminum oxide, non-metal oxides including silica or low surface energy polytetrafluoroethylene, and combinations thereof. Suitable binder resins include those described above as suitable for charge generation layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoatings may be continuous and typically have a thickness ranging from about 0.5 micrometers to about 10 micrometers, in embodiments from about 2 micrometers to about 6 micrometers.

An example of an anti-curl backing layer is described in U.S. Pat. No. 4,654,284, the entire disclosure of which is incorporated herein by reference. In other embodiments, it may be desirable to coat the back of the substrate with an anticurl layer such as, for example, polycarbonate materials commercially available as MAKROLON® from Bayer Material Science. The thickness of anti-curl backing layers should be sufficient to substantially balance the total forces of the layer or layers on the opposite side of the supporting substrate layer. A thickness for an anti-curl backing layer ranging from about 10 micrometers to about 100 micrometers, in embodiments from about 15 micrometers to about 50 micrometers, is a satisfactory range for flexible photoreceptors.

While the above description has focused on the application of a charge generation dispersion to a multi-layered photoreceptor, including any adhesive layer, a suitable electrically conductive layer, or to a charge transport layer, it will be recognized that the charge generation dispersion of the present disclosure may be applied to other types of architectural devices such as single layer photoreceptors.

The dispersions of the present disclosure, when applied as a charge generation layer to a photoreceptor, provide excellent photoinduced discharge characteristics, cyclic and environmental stability, and acceptable charge deficient spot levels arising from dark injection of charge carriers.

While the above disclosure has discussed embodiments utilizing dispersions prepared herein for the formation of charge generation layers of photoreceptors, any layer of a photoreceptor having a particulate additive including, for example, an overcoat layer, charge transport layer, undercoat layer, hole blocking layer, anti-curl backing layer and the like, may be prepared utilizing the methods of the present disclosure with the same ratios of binder to particulate additive in the Newtonian millbase, the let down composition, and the resulting non-Newtonian dispersion following the same conditions described above for charge generation layers.

For example, the methods of the present disclosure may be utilized to adjust the rheology of a dispersion utilized to form a charge transport layer possessing hole transport molecules including N,N′-diphenyl-N,N′-bis(alkylphenyl)-1,1-biphenyl-4,4′-diamine, wherein the alkyl may be methyl, ethyl, propyl, butyl, hexyl, and the like; N,N′-diphenyl-N,N′-bis(halophenyl)-1,1′-biphenyl-4,4′-diamine, wherein the halo may be a chloro, bromo, fluoro, and the like, tritolylamine, N,N′-bis(3,4 dimethylphenyl)-N″(1-biphenyl)amine, 2-bis((4′-methylphenyl)amino-p-phenyl) 1,1-diphenyl ethylene, 1-bisphenyl-diphenylamino-1-propene, triphenylmethane, bis(4-diethylamine-2-methylphenyl)phenylmethane, 4′-4″-bis(diethylamino)-2′,2″-dimethyltriphenylmethane, N,N′-bis(alkylphenyl)-[1,1′-biphenyl]-4,4′-diamine wherein the alkyl is, for example, methyl, ethyl, propyl, n-butyl, and the like, N,N′-diphenyl-N,N′-bis(3″-methylphenyl)-(1,1′-biphenyl)-4,4′-diamine, and the like. In embodiments, the charge transport layer may also include particulate additives, for example metal oxides including aluminum oxide, non-metal oxides including silica, low surface energy fluoropolymers including low surface energy polytetrafluoroethylene, and the like, and combinations thereof.

Similarly, the methods of the present disclosure may be utilized to adjust the rheology of a dispersion utilized to form an overcoat layer possessing particulate additives, for example metal oxides including aluminum oxide, non-metal oxides including silica, low surface energy fluoropolymers including low surface energy polytetrafluoroethylene, and the like, and combinations thereof.

Processes of imaging, especially xerographic imaging and printing, are also encompassed by the present disclosure. More specifically, photoreceptors of the present disclosure can be selected for a number of different known imaging and printing processes including, for example, electrophotographic imaging processes, especially xerographic imaging and printing processes wherein charged latent images are rendered visible with toner compositions of an appropriate charge polarity. In embodiments, the imaging members may be sensitive in the wavelength region of, for example, from about 450 to about 900 nanometers, typically from about 550 to about 850 nanometers; thus diode lasers can be selected as the light source. Moreover, the imaging members of this disclosure may be useful in color xerographic applications, particularly high-speed color copying and printing processes.

The following Examples illustrate embodiments of the present disclosure. These Examples are intended to be illustrative only and are not intended to limit the scope of the present disclosure. Also, parts and percentages are by weight unless otherwise indicated.

### EXAMPLE 1

Several charge generation layer dispersions having desired pigment/binder ratio and desired rheological properties were prepared from a Newtonian millbase as follows.

Millbase Milling:

In a 2 ounce bottle, 1.5 grams of a polyvinyl chloride/vinyl acetate copolymer (VMCH from Dow Chemical) was dissolved in 34 grams of tetrahydrofuran (THF). The dissolved solution was transferred to a small milling cup of a 01-S attritor; the bottle was rinsed a few times with 10 grams of THF and the solution was added to the milling cup. 4.5 grams of HOGaPc and 150 grams of φ 1.0 mm glass beads (Glen Mills, Inc.) were added to the cup to form a dispersion. The initial solid content was 12% weight and the pigment/binder ratio was 75/25. With the cooling system on, the attritor was run at full speed for 1.5 hours to mill the dispersion. A flow visualization test was utilized to monitor the quality of the millbase.

Briefly, for the flow visualization test, the dispersion was allowed to flow through a small gap, 0.5 mil, where there was an obstruction in the flow path. The gap was formed by holding two pieces of micro slides together with two stainless steel shim strips of given thickness (0.5 mil) to confine the flow. The flow pattern after obstruction was one of the criteria for dispersion quality.

During the milling, additional THF was added to the cup to compensate for solvent loss due to evaporation.

Let Down Millbase for Centrifugation:

The actual solid content of resulting millbase was measured (150° C. oven for at least 30 minutes) and then the proper amount of liquid was added to the system to adjust the solid content to a given level for centrifugation (e.g., 10%).

Centrifuge Millbase:

The millbase was centrifuged in a IEC HN-SII centrifuge manufactured by DAMON/IEC at 4800 rpm for 30 minutes to remove large/undermilled particles. The upper portion of the dispersion was collected and the actual solid content measured.

Let Down Millbase for Coating:

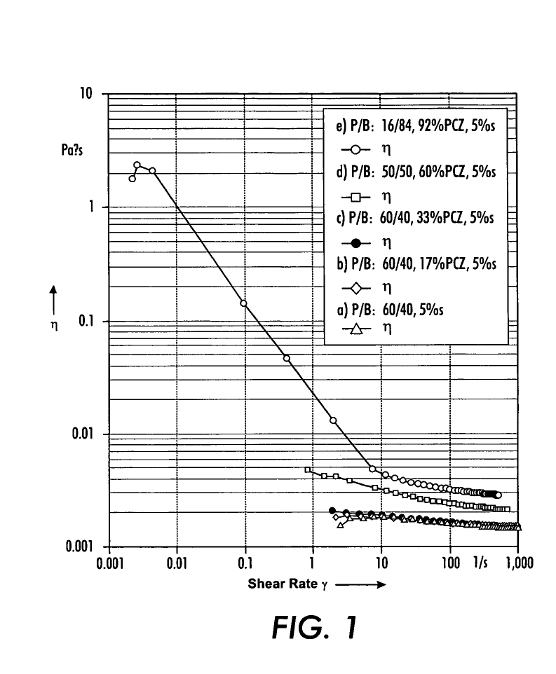

The centrifuged millbase was let down to the target pigment/binder ratio and concentration using PCZ200/THF and VMCH/THF stock solutions (ca. 10% wt) and extra THF solvent. By controlling the PCZ/VMCH ratio, dispersions with different rheological properties were obtained, ranging from Newtonian to near-Newtonian or Non-Newtonian. FIG. 1 shows the rheological properties of HOGaPc/VMCH/PCZ200/THF dispersions (5.0% solids) at varying ratios set forth below:

a) PIGMENT/BINDER=60/40, PCZ/VMCH=0/100 (Newtonian)

b) PIGMENT/BINDER=60/40, PCZ/VMCH=17/83 (Near-Newtonian)

c) PIGMENT/BINDER=60/40, PCZ/VMCH=33/67 (Near-Newtonian)

d) PIGMENT/BINDER=50/50, PCZ/VMCH=60/40 (Non-Newtonian)

e) PIGMENT/BINDER=16/84, PCZ/VMCH=92/8 (Non-Newtonian).

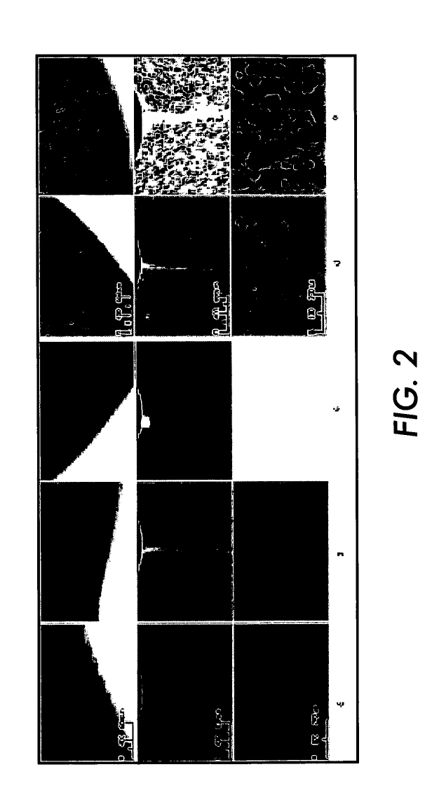

The data were obtained by a Paar Physica UM Rheometer with a Z-1 DIN double gap measuring unit and FIG. 2 shows photographs obtained by the FlowVis testing as described above for these dispersions.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for preparing a non-Newtonian dispersion for fabricating a layer of a photoreceptor comprising:
contacting a particulate additive and a first binder resin in a liquid to form a Newtonian millbase;
contacting the Newtonian millbase with at least a let down solution comprising a second binder resin and a solvent to obtain the non-Newtonian dispersion.

2. The method of claim 1, wherein the first binder resin and the second binder resin are the same or different and are selected from the group consisting of polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

3. The method of claim 1, wherein the first binder resin and the second binder resin are the same or different and are selected from the group consisting of poly(ethylene terephthalate), poly(tetramethylene hexamethylene diurethane), poly(styrene-co-maleic anhydride), polybutadiene-graft-poly(methyl acrylate-co-acrylontrile), poly(1,4-cyclohexane sulfone), poly(phenylene oxide), poly(phenylene sulfone), poly(phenylene oxide-co-phenylene sulfone), poly(ethylene-co-acrylic acid), poly(dimethylsiloxane), poly(ethyl acrylate), poly(hexamethylene adipamide), poly(pyromellitimide), poly(vinyl amine), poly(2,6-dimethyl-1,4-phenylene oxide), poly(hydroxyethers), poly([(o-cresyl glycidyl ether)-co-formaldehyde], poly(4-tert-butylphenol-co-formaldehyde), poly(4,4′-isopropylidene diphenyl carbonate), poly(4,4′-diphenyl-1,1′-cyclohexane carbonate), poly(4,4′-sulfonyl diphenyl carbonate), poly(4,4′-ethylidene diphenyl carbonate), poly(4,4′-methylidene diphenyl carbonate), poly(4,4′-(1,3-phenylenediisopropylidene)diphenyl carbonate), poly(4,4′-(1,4-phenylenediisopropylidene)diphenyl carbonate), poly(4,4′-hexafluoroisppropylidene diphenyl carbonate, and combinations thereof.

4. The method of claim 2, wherein the layer of the photoreceptor comprises a charge generation layer and the particulate additive comprises a pigment selected from the group consisting of metal phthalocyanines, metal free phthalocyanines, alkylhydroxyl gallium phthalocyanines, hydroxygallium phthalocyanines, and perylenes.

5. The method of claim 2, wherein the layer of the photoreceptor comprises a charge transport layer possessing a hole transport molecule is selected from the group consisting of N,N′-diphenyl-N,N′-bis(alkylphenyl)-1,1-biphenyl-4,4′-diamine, N,N′-diphenyl-N,N′-bis(halophenyl)-1,1′-biphenyl-4,4′-diamine, tritolylamine, N,N′-bis(3,4 dimethylphenyl)-N″(1-biphenyl)amine, 2-bis((4′-methylphenyl)amino-p-phenyl) 1,1-diphenyl ethylene, 1-bisphenyl-diphenylamino-1-propene, triphenylmethane, bis(4-diethylamine-2-methylphenyl)phenylmethane, 4′-4″-bis(diethylamino)-2′,2″-dimethyltriphenylmethane, N,N′-bis(alkylphenyl)-[1,1′-biphenyl]-4,4′-diamine, and N,N′-diphenyl-N,N′-bis(3″-methylphenyl)-(1,1′-biphenyl)-4,4′-diamine.

6. The method of claim 5, wherein the charge transport layer further comprises a particulate additive selected from the group consisting of low surface energy fluoropolymers, metal oxides, non-metal oxides and combinations thereof.

7. The method of claim 2, wherein the layer of the photoreceptor comprises an overcoat layer and the particulate additive is selected from the group consisting of low surface energy fluoropolymers, metal oxides, non-metal oxides and combinations thereof.

8. The method of claim 1, wherein the amount of binder resin in the Newtonian millbase is from about 99.5% by weight to about 15% by weight of the Newtonian millbase solids, and the amount of particulate additive in the Newtonian millbase is from about 0.5% by weight to about 85% by weight of the Newtonian millbase solids.

9. The method of claim 1, wherein the amount of binder resin in the Newtonian millbase is from about 65% by weight to about 20% by weight of the Newtonian millbase solids, and the amount of particulate additive in the Newtonian millbase is from about 35% by weight to about 80% by weight of the Newtonian millbase solids.

10. The method of claim 1, wherein the liquid utilized to form the Newtonian millbase and the solvent utilized to form the let down solution may be the same or different and are selected from the group consisting of ketones, alcohols, aromatic hydrocarbons, halogenated aliphatic hydrocarbons, ethers, amines, amides, esters, and mixtures thereof.

11. The method of claim 1, wherein the amount of binder resin in the let down composition is from about 0% by weight to about 50% by weight of the let down composition.

12. The method of claim 1, wherein the non-Newtonian dispersion has a ratio of particulate additive to binder resin from about 85:15 to about 0.5:99.5 by weight.

13. The method of claim 1, further comprising centrifuging the Newtonian millbase at a centrifugal force ranging from about 500 g to about 8000 g prior to contacting the Newtonian millbase with at least one let down solution.

14. A method for fabricating a charge generation layer of a photoreceptor comprising:
contacting a first binder resin, a pigment and a liquid to form a millbase;
centrifuging the Newtonian millbase;
contacting the Newtonian millbase with a let down solution comprising a second binder resin and a solvent to obtain a non-Newtonian dispersion having a ratio of pigment to binder of from about 85:15 to about 0.5:99.5 by weight; and
forming a charge generation layer on a photoreceptor by applying the non-Newtonian dispersion to a previously applied layer of the photoreceptor.

15. The method of claim 14, wherein the first binder resin and the second binder resin are the same or different and are selected from the group consisting of polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

16. The method of claim 14, wherein the pigment is selected from the group consisting of metal phthalocyanines, metal free phthalocyanines, alkylhydroxyl gallium phthalocyanines, hydroxygallium phthalocyanines, and perylenes.

17. The method of claim 14, wherein the pigment is selected from the group consisting of bis(benzimidazo)perylene, titanyl phthalocyanines, vanadyl phthalocyanines, Type V hydroxygallium phthalocyanines, selenium, selenium alloys, and trigonal selenium.

18. The method of claim 14, wherein the Newtonian millbase is centrifuged at a centrifugal force ranging from about 500 g to about 8000 g.

19. The method of claim 14, wherein the liquid utilized to form the Newtonian millbase and the solvent utilized to form the let down solution may be the same or different and are selected from the group consisting of ketones, alcohols, aromatic hydrocarbons, halogenated aliphatic hydrocarbons, ethers, amines, amides, esters, and mixtures thereof.

20. The method of claim 14, wherein the non-Newtonian dispersion is applied to the photoreceptor by a method selected from the group consisting of dip coating, slot coating, slide coating, die coating, roll coating, wire wound rod coating, gravure coating, spray coating, and the like.

21. A photoreceptor having a layer formed from a non-Newtonian dispersion comprising:
a Newtonian millbase comprising a first binder resin, a particulate additive and a liquid;
at least one let down solution comprising at least one binder resin and a solvent.

22. The photoreceptor of claim 21, wherein the configuration of the photoreceptor is selected from the group consisting of belt and web.

23. The photoreceptor of claim 21, wherein the non-Newtonian dispersion has a ratio of particulate additive to binder from about 85:15 to about 0.5:99.5 by weight.
